(19) United States
(12) Patent Application Publication
(10) Pub. No.: US 2019/0191849 A1
(43) Pub. Date: Jun. 27, 2019

(54) MICROBLADING STENCILS FOR PERMANENT MAKEUP APPLICATION

(71) Applicant: Jaclyn Warren, Mesa, AZ (US)

(72) Inventor: Jaclyn Warren, Mesa, AZ (US)

(21) Appl. No.: 16/231,465

(22) Filed: Dec. 22, 2018

Related U.S. Application Data
(60) Provisional application No. 62/610,368, filed on Dec. 26, 2017.

(51) Int. Cl. A45D 40/30; A45D 40/26; A61Q 1/02

(52) U.S. Cl. CPC A45D 40/30; A45D 2040/0006; A61Q 1/025; A45D 40/26

(57) ABSTRACT

Disclosed are microblading stencils for permanent makeup application. A pair of stencils is provided, which are manufactured from a flexible, disposable material such as acetate. The stencils provide transfer images of a perfectly symmetrical pair of eyebrows. The images are adhesive and may be easily transferred to the forehead of the client, providing hair strokes within the contours of each image. The user may then use the hair strokes as a guide when using a tattoo needle and ink, creating permanent images on the client's skin.

### RELATED APPLICATION(S)

Under provisions of 35 U.S.C. § 119e, the Applicant(s) claim the benefit of U.S. provisional application No. 62/610,368 filed on Dec. 26, 2017 which is incorporated herein by reference.

### FIELD OF THE INVENTION

The invention relates generally to tattoo application tools and accessories, and in particular to microblading stencils for permanent makeup applications.

### BACKGROUND OF THE INVENTION

The makeup artists have recently developed the practice of permanently applying the appearance of certain types of makeup, by using a tattoo needle and ink. The practice is known as microblading and is most frequently used to apply the appearance of perfect, symmetrical eyebrows. However, due to the curvature of the forehead it is very difficult to make the eyebrows appear perfectly symmetrical.

A search of the prior art reveals various devices which have been developed to address this set of problems, or related problems. None are closely related to the present disclosure, but several include features which resemble those of the present disclosure. Each has proven to be less than satisfactory for the present purpose in its own way.

The U.S. Patent Appl. No. 2006/0249173A1 (priority May 3, 2005) titled “Stencil and method for tattoo or cosmetic application”, provides a stencil for applying tattoos or cosmetics to the body includes a stretchable membrane which includes an aperture of selected shape for confining application of the tattoos or cosmetics. A peripheral frame may be attached to the membrane and be adjustable in peripheral length and shape for altering the shape of the aperture formed within the membrane in response to the shape of the peripheral frame. At least a pair of stencils may be temporarily attached by a member of adjustable length for positioning left and right stencils on the body during application of tattoos or cosmetics to the body within the template area of the aperture. However, it may be difficult to get the appearance of perfect, symmetrical eyebrows using the disclosed stencils with stretchable membranes.

Further, U.S. Pat. No. 6,161,554 (priority Nov. 12, 1998) titled “Removable tattoo eyebrows” provides removable tattoo eyebrows for the cosmetic enhancement of a human face where eyebrows are usually present. The removable tattoo eyebrows are temporary, simulated eyebrows composed of a moisture activated transferable colorant material, preferably located on a sheet of plastic, cloth or paper. The removable tattoo eyebrows come in various designs, sizes, shapes and/or colors. The removable tattoo eyebrows can be quickly and easily transferred onto a human face, by placing the sheet containing the tattoo up against the eyebrow region of the face, and applying moisture from a damp cloth or sponge. However, it may be difficult to make the eyebrows appear perfectly symmetrical using the disclosed removable tattoo eyebrows as they may not allow customization according to the curvature of the forehead of a particular user. Accordingly, there is a need for an improved microblading stencils for permanent makeup application, which provide a perfectly symmetrical pair of eyebrow stencils for easy application by a makeup artist that may also overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Accordingly, the invention is directed to microblading stencils for permanent makeup application. A pair of stencils is provided, which are manufactured from a flexible, disposable material such as acetate. The stencils provide transfer images of a perfectly symmetrical pair of eyebrows. The images are adhesive and may be easily transferred to the forehead of the client, providing hair strokes within the contours of each image. The user may then use the hair strokes as a guide when using a tattoo needle and ink, creating permanent images on the client's skin.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top view of a microblading stencil, in accordance with a first exemplary embodiment.

FIG. 2 is a front view of the microblading stencil of FIG. 1, according to an embodiment.

FIG. 3 is a side view of the microblading stencil of FIG. 1, according to an embodiment.

FIG. 4 is a rear view of the microblading stencil of FIG. 1, according to an embodiment.

FIG. 5 is a front right perspective view the microblading stencil of FIG. 1, according to an embodiment.

FIG. 6 is a front left perspective view the microblading stencil of FIG. 1, according to an embodiment.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of makeup applications, embodiments of the present disclosure are not limited to use only in this context.

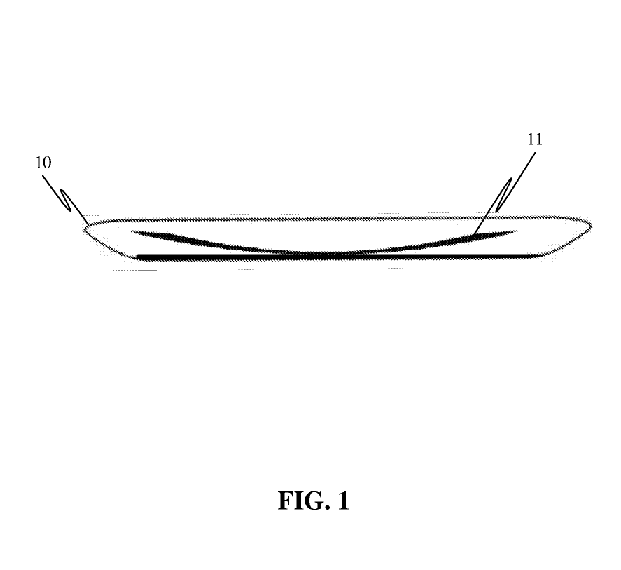

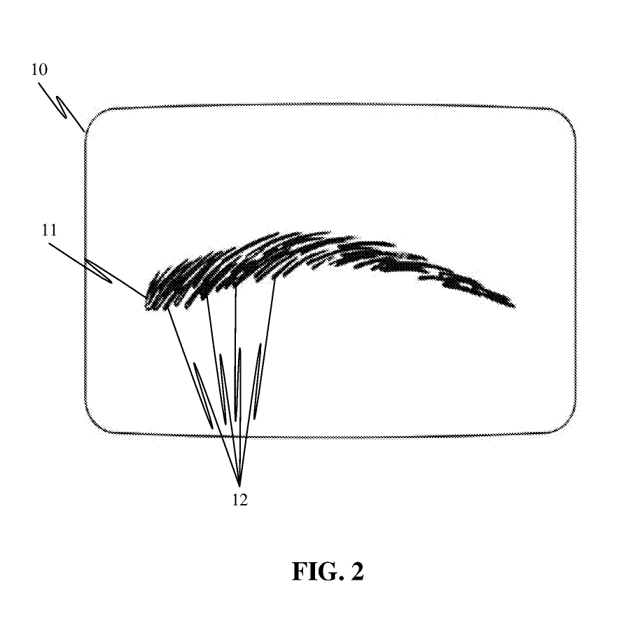

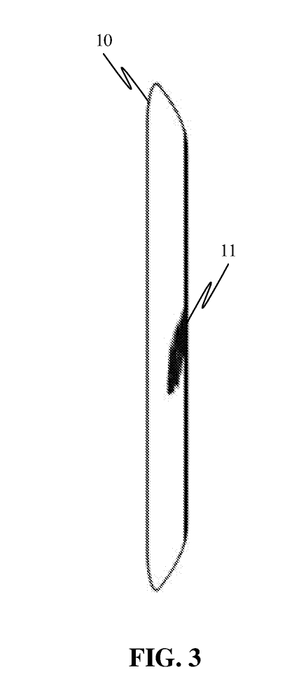

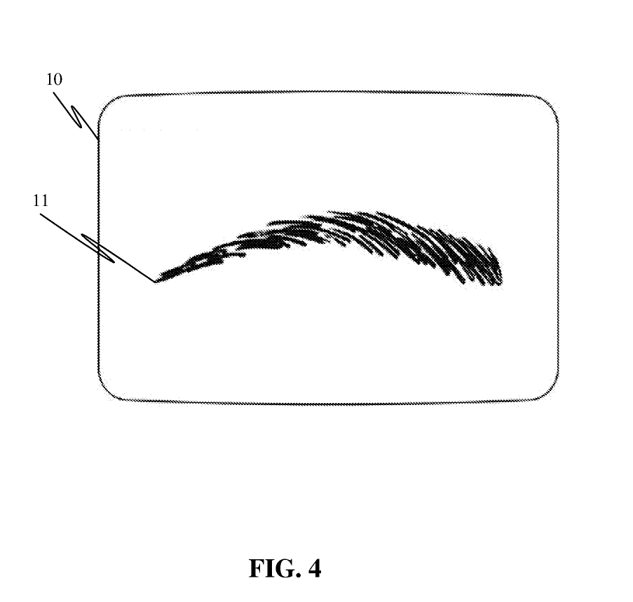

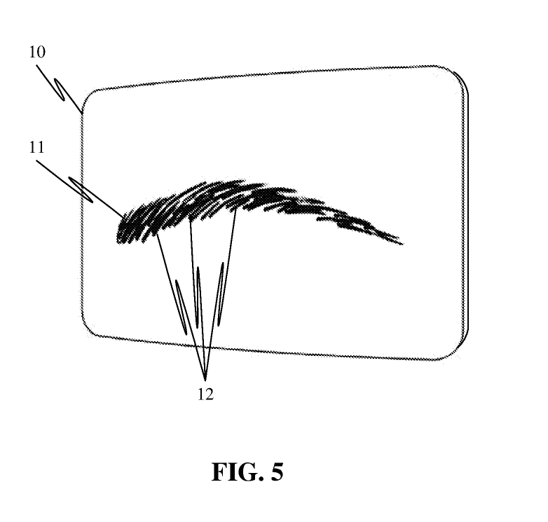

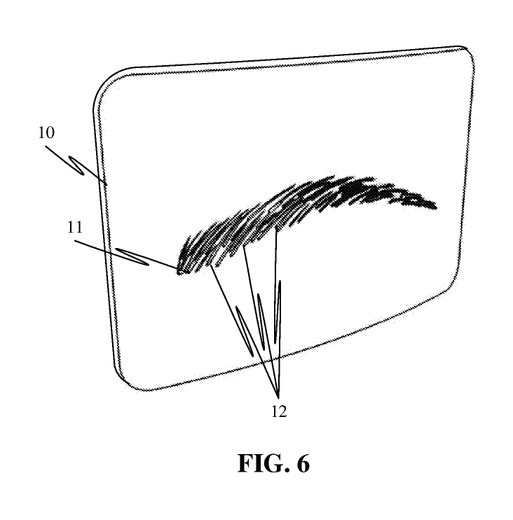

FIG. 1 is a top view of a microblading stencil 10 for permanent makeup application, in accordance with a first exemplary embodiment. FIG. 2 is a front view of the microblading stencil 10. The microblading stencil 10 includes an image 11 comprising hair strokes 12. In an embodiment, the image 11 may be made of a colored material, such as a paint. In another embodiment, the image 11 may be made of a colored material with adhesive property. In another embodiment, the image 11 may be an artifact which may be partially or fully embedded in the stencil 10. The FIGS. 1-6 are not drawn to scale. The thickness in FIGS. 1 and 3 is exaggerated for clarity. FIGS. 1-6 are intended to provide a general understanding of the structure of various embodiments

The microblading stencil 10 is intended for use in the application of permanent makeup images with a tattoo needle, however, this is not intended as a limitation. Alternate embodiments, which may be used for other purposes, are contemplated.

According to an embodiment, a pair of microblading stencils 10, which are manufactured from a flexible, disposable material, such as acetate. The pair of stencils 10 allow for transfer of images 11 of a perfectly symmetrical pair of eyebrows. The images 11 have adhesive property such that they may be easily transferred to the forehead of a client, providing hair strokes 12 within the contours of each image 11.

A user (such as a makeup artist) may apply the microblading stencil 10 to a client's forehead. The user may adjust the position of the stencil 10 as desired, and then press firmly along the entire length of the image 11. The user may then peel away the flexible, disposable material (the backing), leaving the image 11 affixed to the user's forehead. Further, the user may use the hair strokes 12 as a guide when using a tattoo needle and ink, creating permanent images on the client's skin.

The stencil 10 is preferably manufactured from a flexible, disposable material which is transparent, such as acetate, cellophane, or plastic. Components and methods listed above are preferable, but artisans will recognize that alternate components and methods could be selected without altering the scope of the invention.

Although the invention has been explained in relation to its preferred embodiment, it is to be understood that many other possible modifications and variations can be made without departing from the spirit and scope of the invention.

What is claimed is:

1. Microblading stencils for permanent makeup application, comprised of a pair of stencils, which are manufactured from a flexible, disposable material such as acetate, providing adhesive transfer images of a perfectly symmetrical pair of eyebrows which may be easily transferred to the forehead of the client, providing hair strokes within the contours of each image.

2. The stencils of claim 1, wherein the user may apply the stencil to the client's forehead, adjust the position of the stencil as desired, and then press firmly along the entire length of the image.

3. The stencils of claim 1, wherein the user may then peel away the backing, leaving the image affixed to the user's forehead, and use the hair strokes as a guide when using a tattoo needle and ink, creating permanent images on the client's skin.

4. The stencils of claim 1, wherein the stencil is preferably manufactured from a flexible, disposable material which is transparent, such as acetate, cellophane, or plastic.
